(19) United States
(12) Patent Application Publication
(10) Pub. No.: US 2009/0267377 A1
(43) Pub. Date: Oct. 29, 2009

(54) Sun Shade Operation Device

(75) Inventor: Takahiro Horinaka, Hyogo (JP)

Correspondence Address: Rahman LLC, 10025 Governor Warfield Parkway, Suite 110, Columbia, MD, 21044, US

(73) Assignee: HI-LEX CORPORATION, Hyogo (JP)

(21) Appl. No.: 12/302,825

(22) PCT Filed: May 30, 2007
(86) PCT No.: PCT/JP2007/060992

§ 371 Date: Nov. 28, 2008

(30) Foreign Application Priority Data
Jun. 1, 2006 (JP) 2006-153910

(51) Int. Cl. B60J 3/00

(52) U.S. Cl. 296/97.8

(57) ABSTRACT

The sun shade operation device 100 of the present invention includes a drive unit M; at least one shaft 1 directly or indirectly transmitted with a rotary torque generated by the drive unit M; a plurality of gears 2 integrally rotating with the shaft 1 with the one shaft 1 as center of rotation; a plurality of control cables 41, 42, 43 for engaging with the gears 2 and moving in a longitudinal direction with the rotational movement of the gears 2; and an accommodation body for accommodating one end of the shaft 1 and the plurality of gears 2, and through which the plurality of control cables pass. Furthermore, the accommodation body has a member 32 formed with a space for passing axially adjacent control cables interposed between a pair of sandwiching members 31, 33.

### TECHNICAL FIELD

The present invention relates to a sun shade operation device. More specifically, the present invention relates to a sun shade operation device including a drive unit; at least one shaft directly or indirectly transmitted with a rotary torque generated by the drive unit; a plurality of gears integrally rotating with the shaft with the one shaft as center of rotation; a plurality of control cables for engaging with the gears and moving in a longitudinal direction with the rotational movement of the gears; and an accommodation body for accommodating one end of the shaft and the plurality of gears, and through which the plurality of control cables pass.

### BACKGROUND ART

Conventionally, a sun shade (shade) is used in automobiles to shield the light streaming from a window glass or to protect privacy in a vehicle. The sun shade is generally attached mainly on a window at a back side of the automobile.

The window arranged on a door of a back side of the automobile will be described below. The window glass arranged on the door of the back side of the automobile is arranged with a pillar part to be divided to a vehicle front side and a vehicle back side. This limits an upward and downward slidable window glass to the window glass on the vehicle front side since the window glass cannot be moved to a lower end position of the door due to positional relationship with the rear wheel of the vehicle if one window glass is installed without the window glass divided to the front side and the back side.

When desiring to cover the window glass on the vehicle front side and the vehicle back side with separate sun shades, the sun shade is driven from the lower side to the upper side of the door using the fact that the window glass has a substantially parallelogram (heights of both side edges of the window glass are substantially the same) shape with respect to the vehicle front side, and taking into consideration that a winding part of the sun shade can be hidden in the door thereby improving the appearance. With respect to the window glass on the vehicle back side, the shape thereof is substantially triangular, and thus the entire window glass on the vehicle back side cannot be covered even if the sun shade is driven from the lower side to the upper side similar to the vehicle front side. Thus, the winding device of the sun shade is arranged at the pillar part for dividing the window glass to the window glass on the front side and the window glass on the back side, and the sun shade is driven in the horizontal direction from the vehicle front side to the back side.

Japanese Unexamined Patent Publication No. 2005-153778 discloses a technique of a side surface window blind device of an automobile excelling in convenience such as being able to change the light shielding rate by arranging a winding shaft of a blind sheet in plurals and devising the shape of the blind sheet. In this technique, a drive device for controlling the blind sheet for covering the window on the vehicle front side and a drive device for controlling the blind sheet for covering the window on the vehicle back side are respectively arranged in performing the drive operation of the blind sheet at the window divided by the pillar part.

Japanese Unexamined Patent Publication No. 2003-182358 discloses a technique of a window shade device for the window of the automobile in which the gear arranged in the drive device has a two-stage structure so that three control cables are fed (reeled) with one drive device thereby driving the sun shade for covering the window glasses on the vehicle front side and the vehicle back side, whereby a space does not need to be greatly increased. In this technique, the sun shade for covering the window on the vehicle front side is driven with one gear, and the sun shade for covering the window on the vehicle back side is driven with the other gear.

### DISCLOSURE OF INVENTION

However, the technique of the Japanese Unexamined Patent Publication No. 2005-153778 has problems in that since two drive devices (feeding device of control cable and motor) are arranged in the door, the space in the door is greatly occupied, the weight of the entire vehicle is increased, and the cost in assembling the feeding device is high.

In the technique of the Japanese Unexamined Patent Publication No. 2003-182358, the space occupied by the drive unit in the door is not greatly increased. However, three control cables are moved at two types of speed using a two-stage gear in the drive unit. That is, two control cables for driving the sun shade for covering the window glass on the vehicle front side move at the same speed. Thus, the two control cables for driving the sun shade for covering the window glass on the vehicle front side need to be moved at different speeds if the length of the side edge on the front side and the length of the side edge on the back side in the window glass on the vehicle front side differ, which cannot be responded with the two-stage gear.

Furthermore, if the gear arranged in the feeding device of the control cable has a three-stage structure, the assembly of the feeding device becomes a very complicated task.

In view of the problems of the prior art, the present invention aims to provide a sun shade operation device capable of easily arranging each control cable at a predetermined position in the device and easily performing the assembly of the device even when feeding each control cable at different speeds using gears overlapping in three or more stages to achieve miniaturization of the device.

According to a sun shade operation device of the present invention, the above aim is achieved with a sun shade operation device including a drive unit; at least one shaft directly or indirectly transmitted with a rotary torque generated by the drive unit; a plurality of gears integrally rotating with the shaft with the one shaft as center of rotation; a plurality of control cables for engaging with the gears and moving in a longitudinal direction with the rotational movement of the gears; and an accommodation body for accommodating one end of the shaft and the plurality of gears, and through which the plurality of control cables pass, wherein the accommodation body has a member formed with a space for passing the axially adjacent control cables interposed between a pair of sandwiching members.

The plurality of control cables is preferably a gear control cable.

### BRIEF DESCRIPTION OF DRAWINGS

FIG. 1 is a view showing a state in which a sun shade operation device of the present invention is attached to a door on a back side of a vehicle.

FIG. 2 is a view showing a longitudinal plane of the sun shade operation device of the present invention.

FIG. 3 is a view showing a rotating direction of a gear and a moving direction of each control cable.

FIG. 4(a) is a perspective view showing a first sandwiching member of an accommodation body of the sun shade operation device of the present invention, (b) is a perspective view showing an intermediate layer holding member, and (c) is a perspective view showing a second sandwiching member.

FIG. 5(a) is a view showing an assembly process of the sun shade operation device of the present invention, and is a plan view of a state in which a first control cable and a second control cable are arranged in the first sandwiching member attached with the gear, and (b) is a longitudinal cross-sectional view of FIG. 5(a).

FIG. 6(a) is a view showing an assembly process of the sun shade operation device of the present invention, and is a plan view of a state in which the intermediate layer holding member is attached to the state of FIG. 5(a), and (b) is a longitudinal cross-sectional view of FIG. 6(a).

FIG. 7(a) is a view showing an assembly process of the sun shade operation device of the present invention, and is a plan view showing a state in which a third control cable is arranged to the state of FIG. 6(a), and (b) is a longitudinal cross-sectional view in the state of FIG. 7(a).

FIG. 8(a) is a view showing an assembly process of the sun shade operation device of the present invention, and is a plan view showing a state in which the second sandwiching member is attached to the state of FIG. 7(a), and (b) is a longitudinal cross-sectional view in the state of FIG. 8(a).

FIGS. 9(a) to (c) are views showing the movement of the sun shade of when the sun shade operation device of the present invention is driven.

FIG. 10 is a longitudinal cross-sectional view showing another example of the sun shade operation device of the present invention.

FIG. 11 is a longitudinal cross-sectional view showing another further example of the sun shade operation device of the present invention.

### BEST MODE FOR CARRYING OUT THE INVENTION

A sun shade operation device of the present invention includes a drive unit; at least one shaft directly or indirectly transmitted with a rotary torque generated by the drive unit; a plurality of gears integrally rotating with the shaft with the one shaft as center of rotation; a plurality of control cables for engaging with the gears and moving in a longitudinal direction with the rotational movement of the gears; and an accommodation body for accommodating one end of the shaft and the plurality of gears, and through which the plurality of control cables pass. The accommodation body has a member formed with a space for passing the axially adjacent control cables interposed between a pair of sandwiching members.

The sun shade operation device of the present invention will be described in detail below with reference to the accompanying drawings.

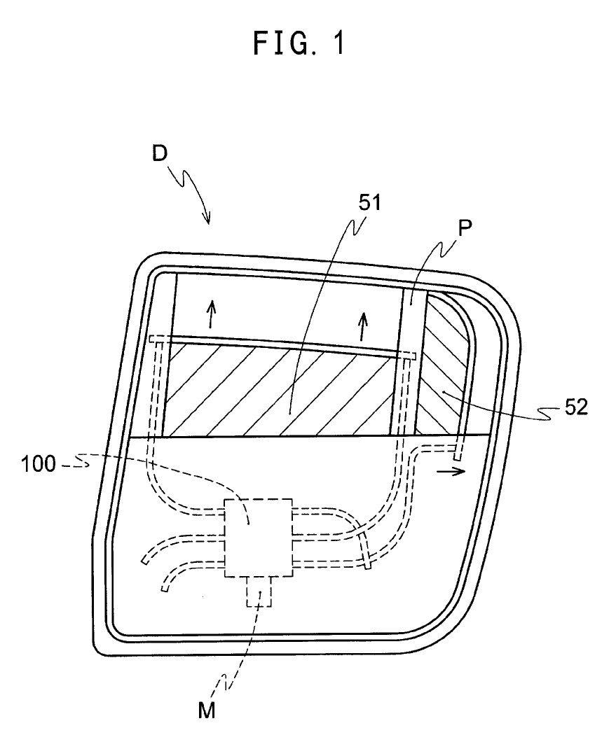

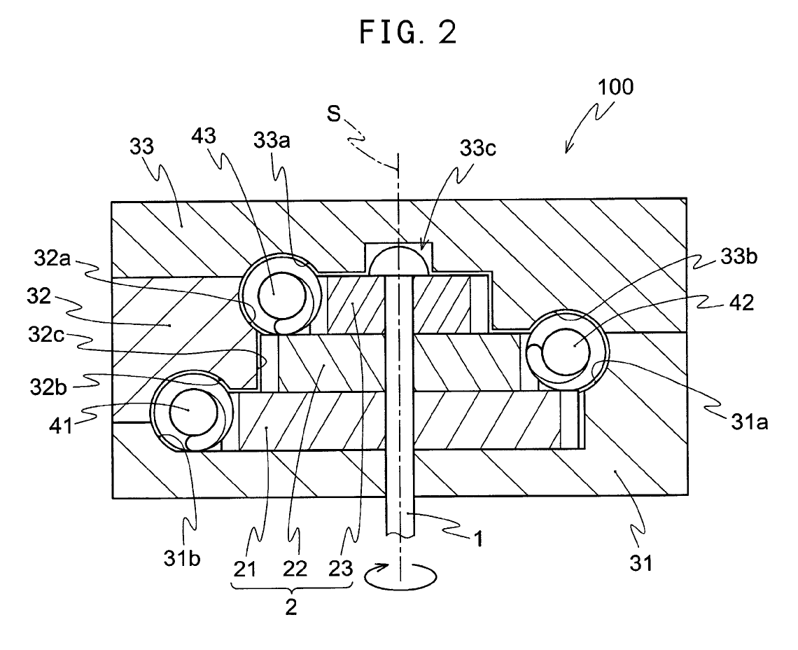

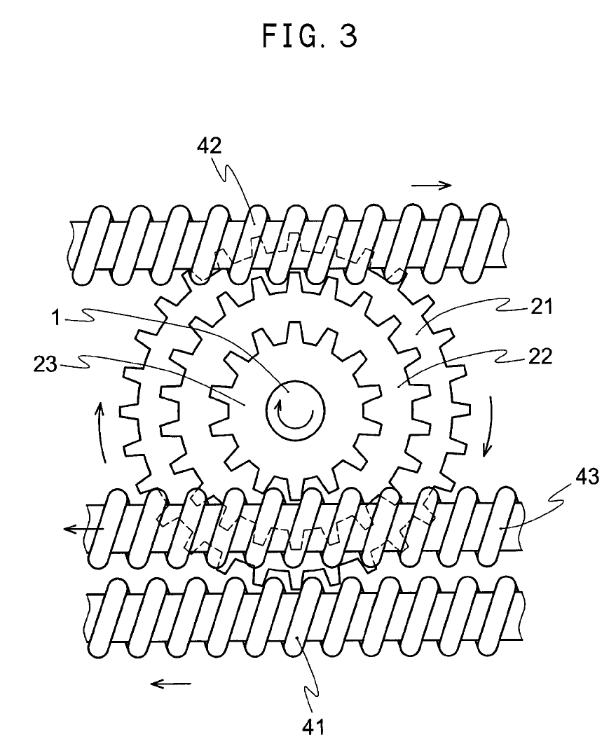

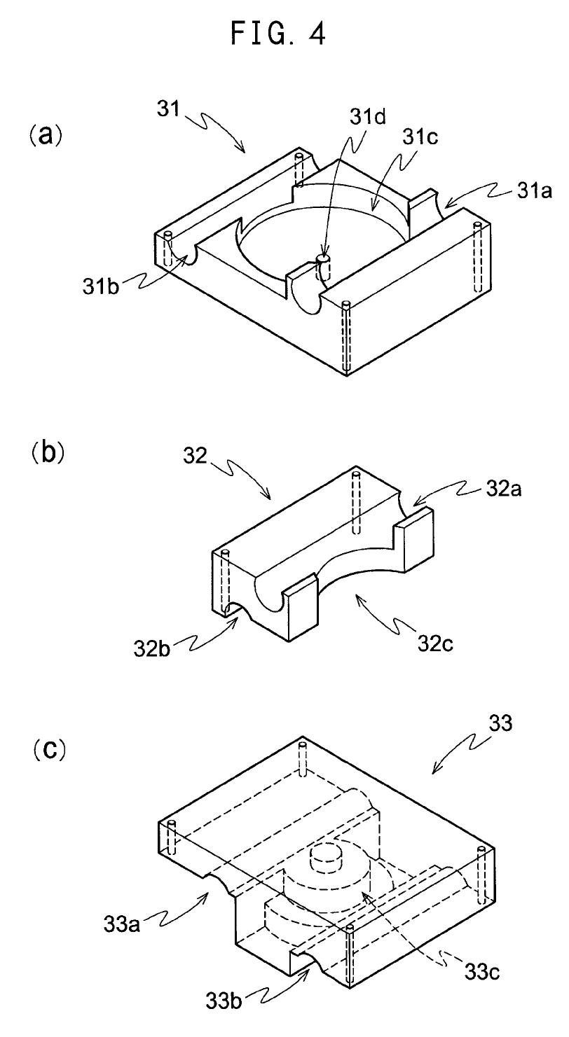

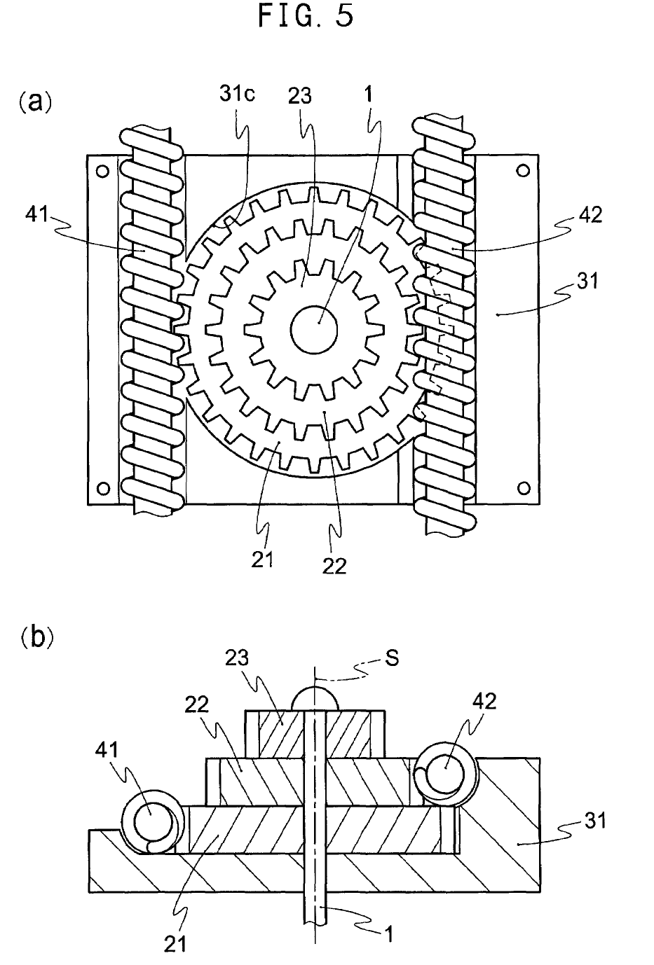

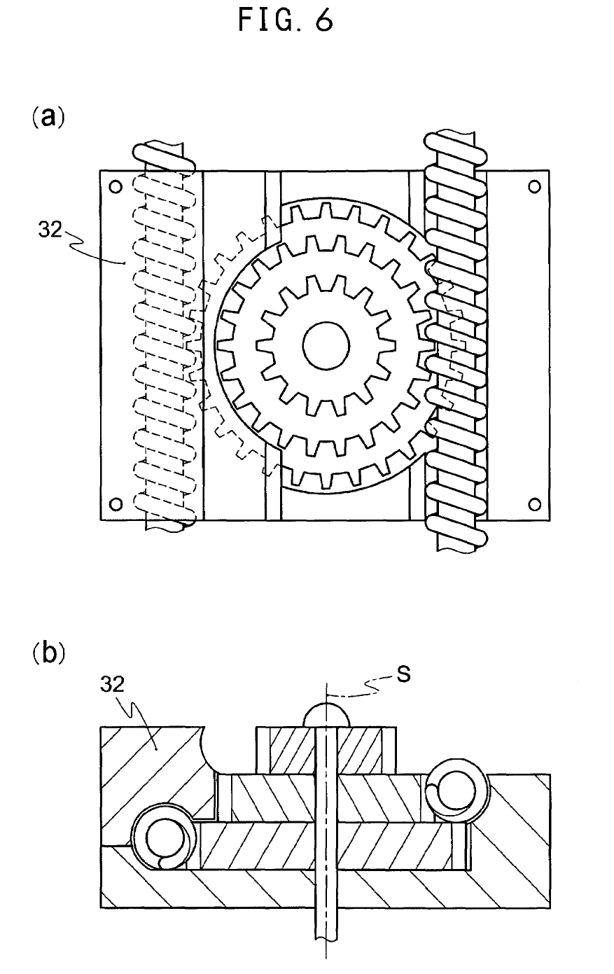

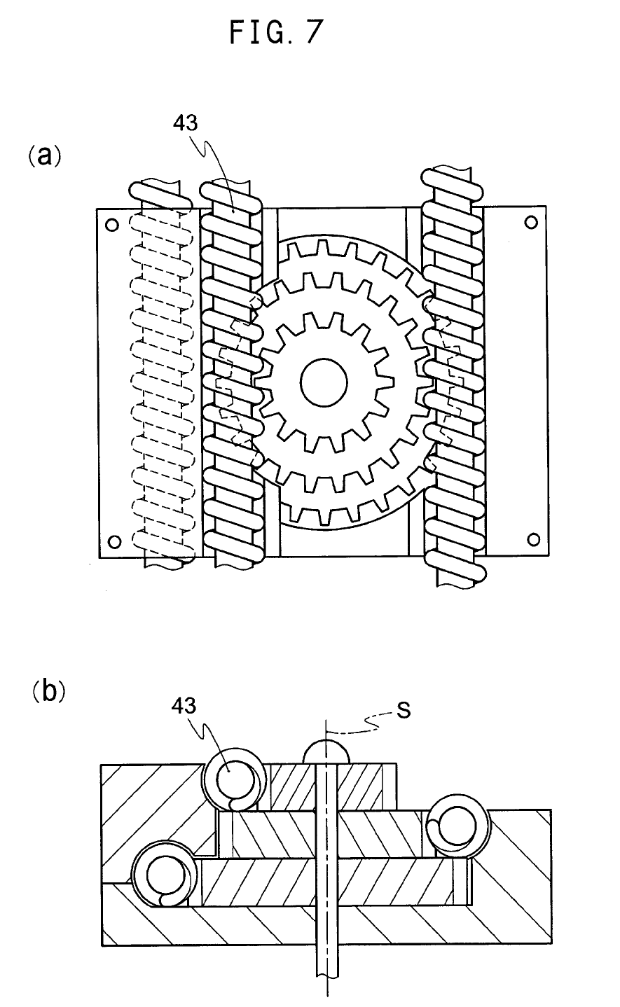

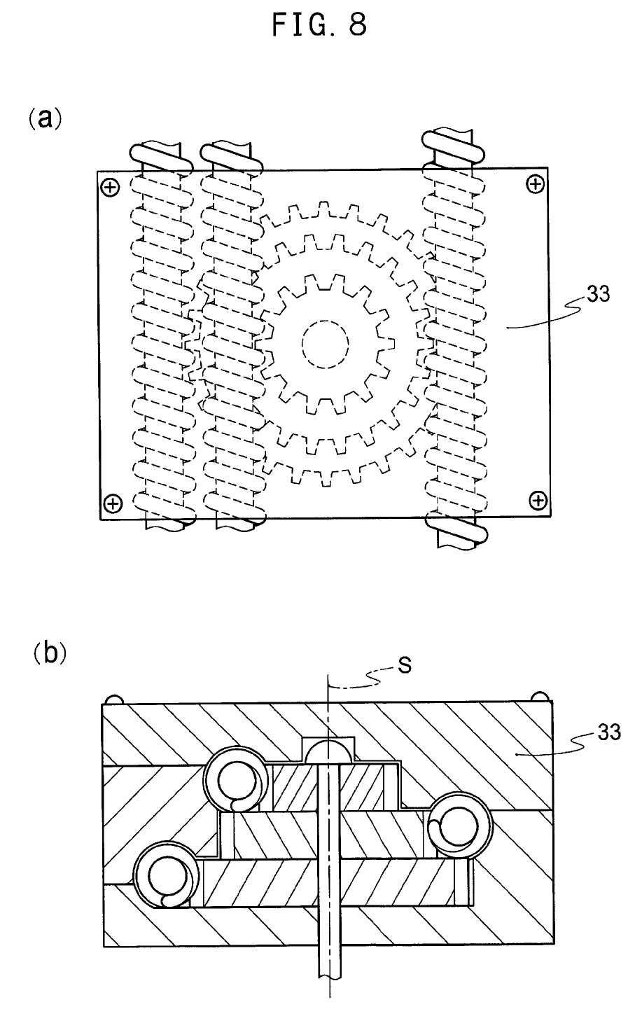

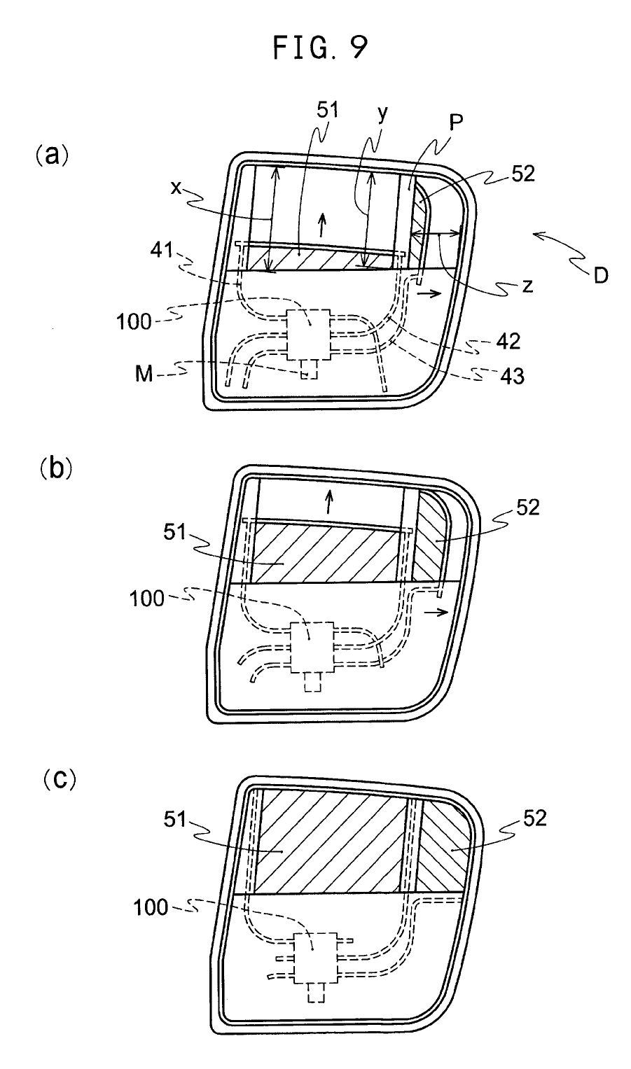

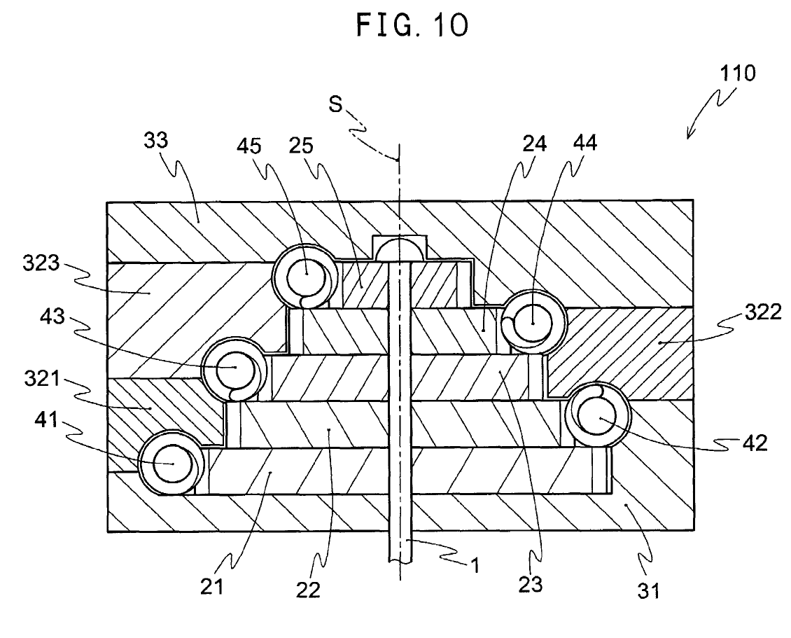

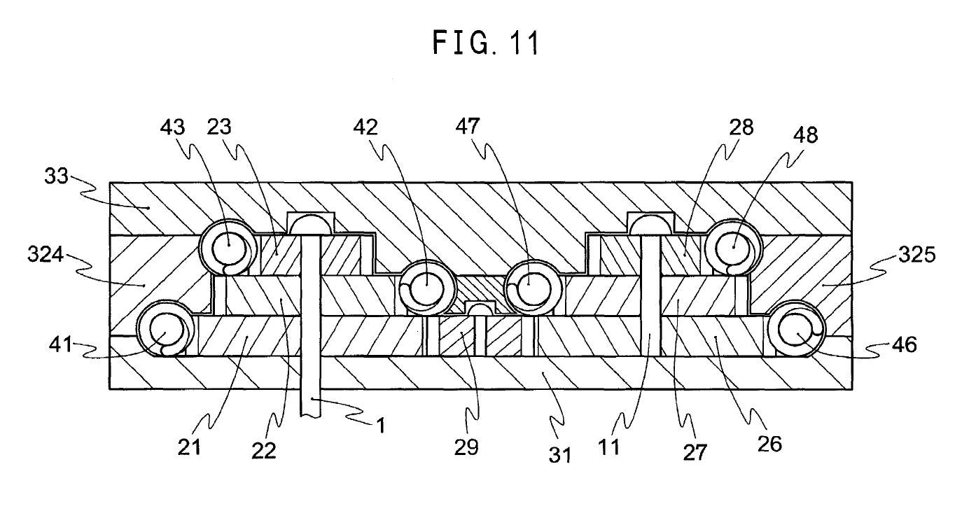

FIG. 1 is a view showing a state in which the sun shade operation device of the present invention is attached to a door on a back side of a vehicle; FIG. 2 is a view showing a longitudinal plane of the sun shade operation device of the present invention; FIG. 3 is a view showing a rotating direction of the gear and a moving direction of each control cable; FIG. 4(a) is a perspective view showing a first sandwiching member of the accommodation body of the sun shade operation device of the present invention, (b) is a perspective view showing an intermediate layer holding member, and (c) is a perspective view showing a second sandwiching member; FIG. 5(a) is a view showing an assembly process of the sun shade operation device of the present invention, and is a plan view of a state in which a first control cable and a second control cable are arranged in the first sandwiching member attached with the gear, and (b) is a longitudinal cross-sectional view of FIG. 5(a); FIG. 6(a) is a view showing an assembly process of the sun shade operation device of the present invention, and is a plan view of a state in which the intermediate layer holding member is attached to the state of FIG. 5(a), and (b) is a longitudinal cross-sectional view of FIG. 6(a); FIG. 7(a) is a view showing an assembly process of the sun shade operation device of the present invention, and is a plan view showing a state in which a third control cable is arranged to the state of FIG. 6(a), and (b) is a longitudinal cross-sectional view in the state of FIG. 7(a); FIG. 8(a) is a view showing an assembly process of the sun shade operation device of the present invention, and is a plan view showing a state in which the second sandwiching member is attached to the state of FIG. 7(a), and (b) is a longitudinal cross-sectional view in the state of FIG. 8(a); FIGS. 9(a) to (c) are views showing the movement of the sun shade of when the sun shade operation device of the present invention is driven; FIG. 10 is a longitudinal cross-sectional view showing another example of the sun shade operation device of the present invention; and FIG. 11 is a longitudinal cross-sectional view showing another further example of the sun shade operation device of the present invention.

### Embodiment 1

The configuration of a sun shade operation device 100 of the present embodiment will be described with reference to FIG. 1 to FIG. 4.

The sun shade operation device 100 of the present embodiment is configured by a shaft 1 transmitted with the rotary torque generated by a drive unit M; three gears 2 fixed to the shaft 1 with the shaft 1 as center of rotation; three control cables 4 arranged so as to engage with the respective gear; and an accommodation body 3 for accommodating one end of the shaft 1 and the gears 2, and passing the control cables 4 at a predetermined position. As shown in FIG. 1, the sun shade operation device 100 is installed in a door D on the back side of a vehicle, a vertically moving shade sheet 51 moves in a vertical direction (FIG. 1, up and down direction in plane of drawing) with the movement of a distal end position of the control cable 4 fed out from the sun shade operation device 100, and a horizontally moving shade sheet 52 moves in a horizontal direction (FIG. 1, left and right direction in plane of drawing).

The shaft 1 has one end side attached to the drive unit M and the other end side incorporated inside the sun shade operation device 100. The three gears 2 are fixed to the portion of the shaft 1 incorporated inside the sun shade operation device 100.

The shaft 1 auto-rotates when the rotary torque generated by the drive unit M on one end side is transmitted to the shaft 1.

The gear 2 includes a first gear 21 having the largest radius of the three gears 2, a third gear 23 having the smallest radius of the three gears, and a second gear 22 having a radius smaller than the radius of the first gear 21 and larger than the radius of the third gear 23. A hole for passing the shaft 1 is formed at the center of each gear 21, 22, and 23. As shown in FIG. 2, the gears are fixed to the shaft 1, which is the center of each gear, in a step-wise manner such that the second gear 22 is on the first gear 21 and the third gear is on the second gear 22 in the sun shade operation device 100.

The three gears 2 integrally rotate in a direction same as the rotating direction of the shaft due to the auto-rotation of the shaft 1 in time of the drive.

The control cable 4 includes a first control cable 41 which engages with the first gear 21, a second control cable 42 which engages with the second gear 22, and a third control cable 43 which engages with the third gear 23. Each control cable 41, 42, 43 is formed on the surface with a convex part in a spiral form so as to engage with the gear 2. When the convex part formed on the surface of the control cable 4 engages with the gear 2, the control cable 4 moves in the longitudinal direction thereof with the rotational movement of the gear 2. Thus, the movement speed of the control cable 4 is determined by the radius of the engaging gear 2 and the rotation speed of the shaft 1, and the moving direction of the control cable is determined by the arrangement position with respect to the engaging gear 2. As shown in FIG. 3, when the shaft 1 rotates in a clockwise direction, the first gear 21, the second gear 22, and the third gear 23 fixed to the shaft 1 rotate in the clockwise direction, and thus the first control cable 41 arranged at the position on the lower side of the plane of drawing of FIG. 3 so as to contact one point on the periphery of the first gear 21 moves towards the left in the plane of drawing of FIG. 3, the second control cable 42 arranged at the position on the upper side of the plane of drawing of FIG. 3 so as to contact one point on the periphery of the second gear 22 moves towards the right in the plane of drawing of FIG. 3, and the third control cable 43 arranged at the position on the lower side of the plane of drawing of FIG. 3 so as to contact one point on the periphery of the third gear 23 moves towards the left in the plane of drawing of FIG. 3. The first control cable 41, that engages the first gear 21 having the largest radius and moves, moves at the fastest speed of the three control cables, and the third control cable 43, that engages the third gear 23 having the smallest radius and moves, moves at the slowest speed of the three control cables.

The control cable preferably uses a gear control cable in which a coil is securely attached to a metal strand wire.

As shown in FIG. 2, the accommodation body 3 is configured by a pair of sandwiching members 3 including a first sandwiching member 31 and a second sandwiching member 33; and an intermediate layer holding member 32 interposed between the first sandwiching member 31 and the second sandwiching member 33 to arrange the axial positions of the first control cable 41 arranged to engage with the first gear 21 and the third control cable 43 arranged to engage with the third gear 23 at the desired positions. The intermediate layer holding member 32 is arranged at a predetermined position occupying one portion in the accommodation body 3, as shown in FIG. 2. The accommodation body 3 is integrated by screw-fitting, for example, a screw to a screw hole passing through the first sandwiching member 31, the intermediate layer holding member 32, and the second sandwiching member 33.

As shown in FIG. 4(a), the first sandwiching member 31 has a shaft pass-through hole 31d for passing the shaft 1, a gear accommodation space 31c of circular shape in plan view for accommodating the first gear 21, a space 31b for passing the first control cable 41, and a space 31a for passing the second control cable 42 formed on the surface that becomes the inner side of the accommodation body 3. The space 31b is linearly formed (FIG. 2, vertical direction in plane of drawing) so as to contact one point on the periphery of the first gear 21, and a plane parallel to the longitudinal direction configuring the space 31b is formed as a concave curved surface. The space 31a is formed parallel to the space 31b with the shaft 1 in between linearly (FIG. 2, vertical direction in plane of drawing) so as to contact one point on the periphery of the second gear 22, and a plane parallel to the longitudinal direction configuring the space 31a is formed as a concave curved surface.

As shown in FIG. 4(c), the second sandwiching member 33 has a gear accommodation hole 33c of circular shape in plan view for accommodating the three gears 2, a space 33b for passing the second control cable 42, and a space 33a for passing the third control cable 43 formed on the surface that becomes the inner side of the accommodation body 3. The space 33b is linearly formed (FIG. 2, vertical direction in plane of drawing) to be integral with the space 31a so as to contact one point on the periphery of the second gear 22, and a plane parallel to the longitudinal direction configuring the space 33b is formed as a concave curved surface. The space 33a is formed parallel to the space 33b with the shaft 1 in between linearly (FIG. 2, vertical direction in plane of drawing) so as to contact one point on the periphery of the third gear 23, and a plane parallel to the longitudinal direction configuring the space 33a is formed as a concave curved surface.

As shown in FIG. 4(b), the intermediate layer holding member 32 has a gear accommodation space 32c of semicircular shape in plan view for accommodating the second gear 22 formed on the surface that becomes the inner side of the accommodation body 3. The space 32b for passing the first control cable 41 is linearly formed (FIG. 2, vertical direction in plane of drawing) to be integral with the space 31b on the side facing the first sandwiching member 31, and a plane parallel to the longitudinal direction configuring the space 32b is formed as a concave curved surface. The space 32a for passing the third control cable 43 is linearly formed (FIG. 2, vertical direction in plane of drawing) to be integral with the space 33a on the side facing the second sandwiching member 33 so as to contact one point on the periphery of the third gear 23, and a plane parallel to the longitudinal direction configuring the space 32a is formed as a concave curved surface.

The drive unit M is not particularly limited, but a motor for converting electric energy to machine rotational movement energy can be used.

According to the above-described configuration, the assembly process of the sun shade operation device 100 of the present invention will be described below using FIG. 5 to FIG. 8. The assembly task may be carried out by human hands, or may be carried out using a device such as assembling robot.

First, the gear 2 of three-stages fixed to the shaft 1 is accommodated in the gear accommodation space 31c of the first sandwiching member 31, and then the first control cable 41 is arranged in the space 31b formed in the first sandwiching member 31. The second control cable 42 is then arranged in the space 31a formed in the first sandwiching member 31. Here, the first control cable 41 is arranged so as to engage with the first gear 21 since the space 31b is formed so as to contact the outer periphery of the first gear 21. Furthermore, the second control cable 42 is arranged so as to engage with the second gear 22 since the space 31a is formed so as to contact the outer periphery of the second gear 22 (see FIGS. 5(a) and (b)).

As shown in FIGS. 6(a) and (b), the intermediate layer holding member 32 is arranged such that the space 32b formed in the intermediate layer holding member 32 accommodates the first control cable 41. The first control cable 41 is thus arranged at a predetermined position in the axial direction s (FIG. 6(b), up and down direction in the plane of drawing).

The third control cable 43 is then arranged in the space 32a formed in the intermediate layer holding member 32 arranged in the previous step. Here, the third control cable 43 is arranged so as to engage with the third gear 23 since the space 32a is formed so as to contact the outer periphery of the second gear 23 (see FIGS. 7(a) and (b)).

As shown in FIGS. 8(a) and (b), the second sandwiching member 33 is arranged such that the space 33a formed in the second sandwiching member 33 accommodates the third control cable 43 or such that the space 33b formed in the second sandwiching member 33 accommodates the second control cable 42. The second control cable 42 and the third control cable 43 are thus arranged at predetermined positions in the axial direction s (FIG. 8(b), up and down direction in the plane of drawing).

Lastly, a screw is screw-fit to the screw hole passing through the second sandwiching member 33, the intermediate layer holding member 32, and the first sandwiching member 31, thereby integrating the accommodation body 3.

The operation of the sun shade operation device 100 of the present invention will be described below using FIGS. 9(a) to (c).

First, in response to the rotary torque of the drive unit M, the shaft auto-rotates, and the first gear 21, the second gear 22, and the third gear 23 fixed to the shaft 1 rotate in the same direction as the rotating direction of the shaft 1 and at the rotation speed same as the rotation speed of the shaft 1. The first control cable 41 arranged so as to engage with the first gear 21 then moves in a tangent direction of the first gear 21. The second control cable 42 arranged in parallel with the first control cable 41 with the shaft 1 in between and arranged so as to engage with the second gear 22 moves in a tangent direction of the second gear 22, or the opposite direction to the moving direction of the first control cable 41. Furthermore, the third control cable 43 arranged so as to engage with the third gear 23 moves in a tangent direction of the third gear 23, or the same direction as the first control cable 41. The movement speed of each control cable differs depending on the size of the radius of the engaging gear, as described above, where the first control cable 41 moves at the fastest speed, and then the second control cable 42 moves at the speed slower than the first control cable 41 but at the speed faster than the third control cable 43. The third control cable 43 moves at the slowest speed of the control cable 4.

When the control cable 4 is fed out from the sun shade operation device 100 at different speeds, the opening/closing of the sun shade can be simultaneously terminated even if the length x of the side edge on the front side of the window, the length y of the side edge on the back side of the window, and the window width z all have different lengths, as shown in FIG. 9(a) to FIG. 9(c). For example, if the length x of the side edge on the front side of the window, the length y of the side edge on the back side of the window, and the window width z are in a magnitude relation of equation (1),

(length x of side edge on front side)>(length y of side edge on back side)>(window width z) (1)

the end of the first control cable 41 moving at the fastest speed is connected to the side of the side edge on the front side of the window of the vertically moving shade sheet 51, the end of the second control cable 42, which is the second fastest, is connected to the side of the side edge on the back side of the window of the vertically moving shade sheet 51, and the end of the third control cable 43 moving the slowest is connected to the horizontally moving shade sheet 52.

According to the sun shade operation device 100 of the above embodiment, the intermediate layer holding member 32 formed with the space for passing the axially adjacent control cables is interposed between the pair of sandwiching members 31 and 33, as the accommodation body 3. Thus, even if each control cable 4 is fed out at different speeds using gears overlapping in three or more stages to achieve miniaturization of the device, each control cable 4 can be easily arranged at the predetermined position in the device, and the assembly of the device can be easily carried out.

In the above embodiment, a case where the gears are overlapped in three stages has been described, but the present invention is not limited thereto, and the gears may be overlapped in three or more stages. In this case, a first intermediate layer holding member 321, a second intermediate layer holding member 322, and a third intermediate layer holding member 323 are interposed between the first sandwiching member 31 and the second sandwiching member 33, as shown in FIG. 10.

In the above embodiment, a case where the rotation shaft of the gears is one has been described, but the present invention is not limited thereto, and a plurality of gears may be arranged on each of a plurality of rotation shafts. In this case, the first gear 21 rotates when the shaft 1 transmitted with the rotary torque generated by the drive unit rotates, as shown in FIG. 11. Furthermore, the rotational force is transmitted to a sixth gear 26 having a second shaft 11 as a center via a horizontal coupling gear 29 arranged so as to gear with the first gear 21. Furthermore, the second shaft 11 fixed to the sixth gear 26 rotates with the rotation of the sixth gear 26, and a seventh gear 27 and an eighth gear 28 fixed to the second shaft 11 cooperatively rotate. In this case as well, the sun shade operation device can be easily assembled by interposing a fourth intermediate layer holding member 324 and a fifth intermediate layer holding member 325 between the first sandwiching member 31 and the second sandwiching member 33.

### INDUSTRIAL APPLICABILITY

According to the present invention, the intermediate layer holding member formed with the space for passing the axially adjacent control cables is interposed between the pair of sandwiching members, as the accommodation body. Thus, even if each control cable is fed out at different speeds using gears overlapping in three or more stages to achieve miniaturization of the device, each control cable can be easily arranged at the predetermined position in the device, and the assembly of the device can be easily carried out.

1. A sun shade operation device comprising:
a drive unit;
at least one shaft directly or indirectly transmitted with a rotary torque generated by the drive unit;
a plurality of gears integrally rotating with the shaft with the one shaft as center of rotation;
a plurality of control cables for engaging with the gears and moving in a longitudinal direction with the rotational movement of the gears; and
an accommodation body for accommodating one end of the shaft and the plurality of gears, and through which the plurality of control cables pass; wherein
the accommodation body has a member formed with a space for passing axially adjacent control cables interposed between a pair of sandwiching members.

2. The sun shade operation device of claim 1, wherein the plurality of control cables is a gear control cable.
